(19) United States
(12) Patent Application Publication
(10) Pub. No.: US 2014/0006994 A1
(43) Pub. Date: Jan. 2, 2014

(54) Device, Method, and Graphical User Interface for Displaying a Virtual Keyboard

(71) Applicant: APPLE INC., Cupertino, CA (US)

(72) Inventors: Jonathan Koch, San Francisco, CA (US); Morgan H. Winer, Sunnyvale, CA (US); Elizabeth C.F. Cranfill, San Francisco, CA (US); Stephen W. Swales, Sunnyvale, CA (US)

(73) Assignee: APPLE INC., Cupertino, CA (US)

(21) Appl. No.: 13/797,979

(22) Filed: Mar. 12, 2013

Related U.S. Application Data
(60) Provisional application No. 61/666,764, filed on Jun. 29, 2012.

(51) Int. Cl. G06F 3/0488

(52) U.S. Cl. CPC G06F 3/04886
USPC 715/773

(57) ABSTRACT

An electronic device with a touch-sensitive display and one or more sensors displays an application interface on the display, detects an input that corresponds to a command to display a virtual keyboard in the application interface, detects one or more sensor inputs from the one or more sensors, and in response to detecting the input that corresponds to the command to display the virtual keyboard: in accordance with a determination that the sensor inputs satisfy one or more first criteria, displays the virtual keyboard as a split keyboard on the display; and in accordance with a determination that the sensor inputs satisfy one or more second criteria, distinct from the first criteria, displays the virtual keyboard as an unsplit keyboard on the display.

### RELATED APPLICATION

This application claims priority to U.S. Provisional Application Ser. No. 61/666,764, filed Jun. 29, 2012, which is incorporated by reference herein in its entirety.

### TECHNICAL FIELD

This relates generally to electronic devices with touch-sensitive surfaces, including but not limited to electronic devices with touch-sensitive displays that display a split or unsplit virtual keyboard.

### BACKGROUND

The use of touch-sensitive surfaces as input devices for computers and other electronic computing devices has increased significantly in recent years. Exemplary touch-sensitive surfaces include touch pads and touch screen displays. Such surfaces are widely used to manipulate user interface objects on a display.

Exemplary user interface objects include soft keyboards (also known as “virtual keyboards”). Such keyboards may be either split or unsplit keyboards. A user may need to use such soft keyboards in a file management program (e.g., Finder from Apple Inc. of Cupertino, California), an image management application (e.g., Aperture or iPhoto from Apple Inc. of Cupertino, Calif.), a digital content (e.g., videos and music) management application (e.g., iTunes from Apple Inc. of Cupertino, Calif.), a drawing application, a presentation application (e.g., Keynote from Apple Inc. of Cupertino, Calif.), a word processing application (e.g., Pages from Apple Inc. of Cupertino, Calif.), a website creation application (e.g., iWeb from Apple Inc. of Cupertino, Calif.), a disk authoring application (e.g., iDVD from Apple Inc. of Cupertino, Calif.), or a spreadsheet application (e.g., Numbers from Apple Inc. of Cupertino, Calif.).

But existing methods for displaying the soft keyboard that is best suited to how the device is being held or supported are cumbersome and inefficient. In addition, existing methods take longer than necessary, thereby wasting energy. This latter consideration is particularly important in battery-operated devices.

### SUMMARY

Accordingly, there is a need for electronic devices with faster, more efficient methods and interfaces for displaying the soft keyboard that is best suited to how the device is being held or supported. Such methods and interfaces may complement or replace conventional methods for displaying virtual keyboards. Such methods and interfaces reduce the cognitive burden on a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch screen display”). In some embodiments, the device has a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive surface. In some embodiments, the functions may include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a non-transitory computer readable storage medium or other computer program product configured for execution by one or more processors.

In accordance with some embodiments, a method is performed at an electronic device with a touch-sensitive display and one or more sensors. The method includes: displaying an application interface on the display; detecting an input that corresponds to a command to display a virtual keyboard in the application interface; detecting one or more sensor inputs from the one or more sensors; in response to detecting the input that corresponds to the command to display the virtual keyboard: in accordance with a determination that the sensor inputs satisfy one or more first criteria, displaying the virtual keyboard as a split keyboard on the display, and in accordance with a determination that the sensor inputs satisfy one or more second criteria, distinct from the first criteria, displaying the virtual keyboard as an unsplit keyboard on the display.

In accordance with some embodiments, an electronic device includes a touch-sensitive display, one or more sensors, one or more processors, memory, and one or more programs. The one or more programs are stored in the memory and configured to be executed by the one or more processors. The one or more programs include instructions for: displaying an application interface on the display; detecting an input that corresponds to a command to display a virtual keyboard in the application interface; detecting one or more sensor inputs from the one or more sensors; in response to detecting the input that corresponds to the command to display the virtual keyboard: in accordance with a determination that the sensor inputs satisfy one or more first criteria, displaying the virtual keyboard as a split keyboard on the display, and in accordance with a determination that the sensor inputs satisfy one or more second criteria, distinct from the first criteria, displaying the virtual keyboard as an unsplit keyboard on the display.

In accordance with some embodiments, a computer readable storage medium has stored therein instructions which when executed by an electronic device with a touch-sensitive display and one or more sensors, cause the device to: display an application interface on the display; detect an input that corresponds to a command to display a virtual keyboard in the application interface; detect one or more sensor inputs from the one or more sensors; in response to detecting the input that corresponds to the command to display the virtual keyboard: in accordance with a determination that the sensor inputs satisfy one or more first criteria, display the virtual keyboard as a split keyboard on the display, and in accordance with a determination that the sensor inputs satisfy one or more second criteria, distinct from the first criteria, display the virtual keyboard as an unsplit keyboard on the display.

In accordance with some embodiments, a graphical user interface on an electronic device with a touch-sensitive display and one or more sensors, a memory, and one or more processors to execute one or more programs stored in the memory includes an application interface, wherein, in response to detection of an input that corresponds to a command to display a virtual keyboard in the application interface: in accordance with a determination that one or more sensor inputs detected from the one or more sensors satisfy one or more first criteria, displaying the virtual keyboard as a split keyboard on the display, and in accordance with a determination that the sensor inputs satisfy one or more second criteria, distinct from the first criteria, displaying the virtual keyboard as an unsplit keyboard on the display.

In accordance with some embodiments, an electronic device includes: a touch-sensitive display, one or more sensors; means for displaying an application interface on the display; means for detecting an input that corresponds to a command to display a virtual keyboard in the application interface; means for detecting one or more sensor inputs from the one or more sensors; means, responsive to detecting the input that corresponds to the command to display the virtual keyboard, for: in accordance with a determination that the sensor inputs satisfy one or more first criteria, displaying the virtual keyboard as a split keyboard on the display, and in accordance with a determination that the sensor inputs satisfy one or more second criteria, distinct from the first criteria, displaying the virtual keyboard as an unsplit keyboard on the display.

In accordance with some embodiments, an information processing apparatus for use in an electronic device with a touch-sensitive display and one or more sensors includes: means for displaying an application interface on the display; means for detecting an input that corresponds to a command to display a virtual keyboard in the application interface; means for detecting one or more sensor inputs from the one or more sensors; means, responsive to detecting the input that corresponds to the command to display the virtual keyboard, for: in accordance with a determination that the sensor inputs satisfy one or more first criteria, displaying the virtual keyboard as a split keyboard on the display, and in accordance with a determination that the sensor inputs satisfy one or more second criteria, distinct from the first criteria, displaying the virtual keyboard as an unsplit keyboard on the display.

In accordance with some embodiments, an electronic device includes a touch-sensitive display unit configured to display an application interface, one or more sensor units, and a processing unit coupled to the touch-sensitive display unit and the sensor units. The processing unit is configured to: detect an input that corresponds to a command to display a virtual keyboard in the application interface; detect one or more sensor inputs from the one or more sensor units; in response to detecting the input that corresponds to the command to display the virtual keyboard, in accordance with a determination that the sensor inputs satisfy one or more first criteria, enable display of the virtual keyboard as a split keyboard on the touch-sensitive display unit, and in accordance with a determination that the sensor inputs satisfy one or more second criteria, distinct from the first criteria, enable display of the virtual keyboard as an unsplit keyboard on the touch-sensitive display unit.

Thus, electronic devices with touch-sensitive displays and one or more sensors are provided with faster, more efficient methods and interfaces for displaying the soft keyboard that is best suited to how the device is being held or supported, thereby increasing the effectiveness, efficiency, and user satisfaction with such devices. Such methods and interfaces may complement or replace conventional methods for displaying virtual keyboards.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5E illustrate exemplary user interfaces for displaying a virtual keyboard in accordance with some embodiments.

FIGS. 5F-5G illustrate exemplary portable multifunction devices that have touch-sensitive displays and touch-sensitive surfaces distinct from the touch-sensitive displays in accordance with some embodiments.

FIG. 5H illustrates exemplary angle ranges at which a portable multifunction device may be oriented in accordance with some embodiments.

FIGS. 6A-6D are flow diagrams illustrating a method of displaying a virtual keyboard in accordance with some embodiments.

FIG. 7 is a functional block diagram of an electronic device in accordance with some embodiments.

### DESCRIPTION OF EMBODIMENTS

Many electronic devices have graphical user interfaces with soft keyboards for character entry. On a relatively large portable device, such as a tablet computer, typing on an unsplit soft keyboard may be fine in certain situations, such as when the computer is resting on a solid surface, but problematic in other situations. For example, unsplit keyboards are less convenient for typing when both hands are holding onto the device. Split soft keyboards may be more efficient in these situations. But the use of both split and unsplit keyboards raises issues that have not been recognized and/or properly addressed, such as:
How to automatically display the keyboard that is best suited to how the device is being held or supported; and
How to easily convert between an unsplit keyboard and a split keyboard.

The embodiments described below address these issues and related issues.

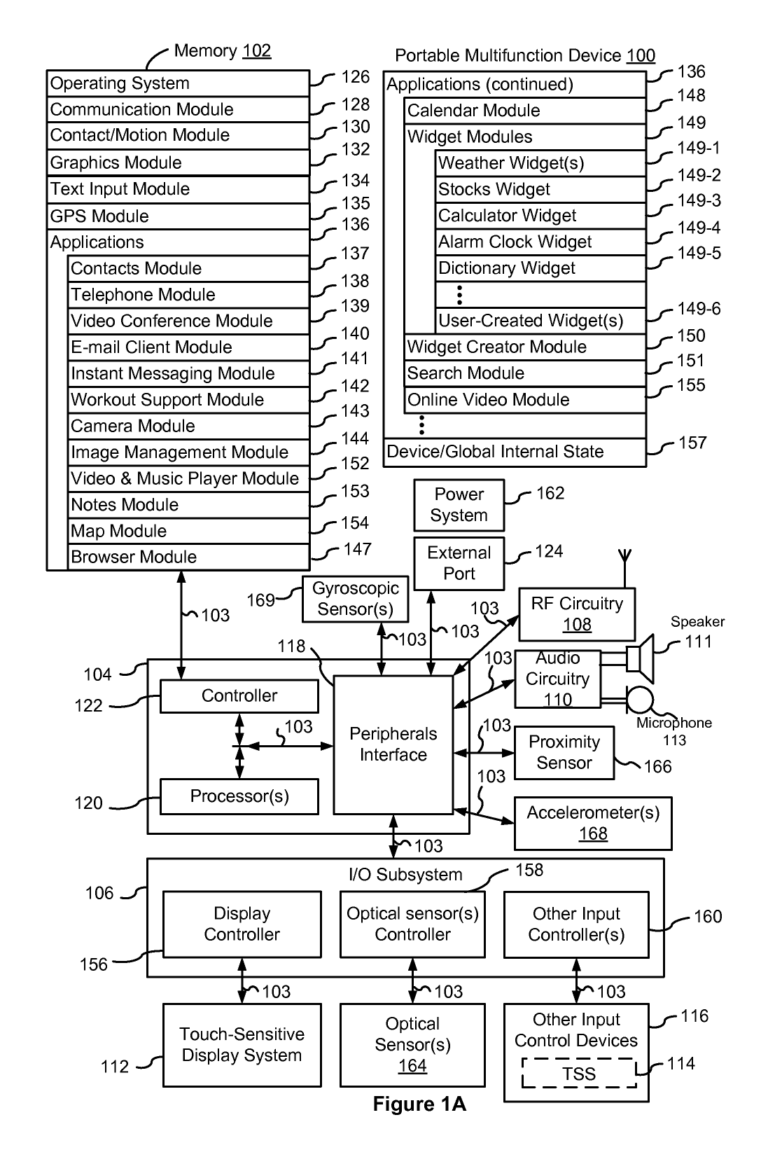

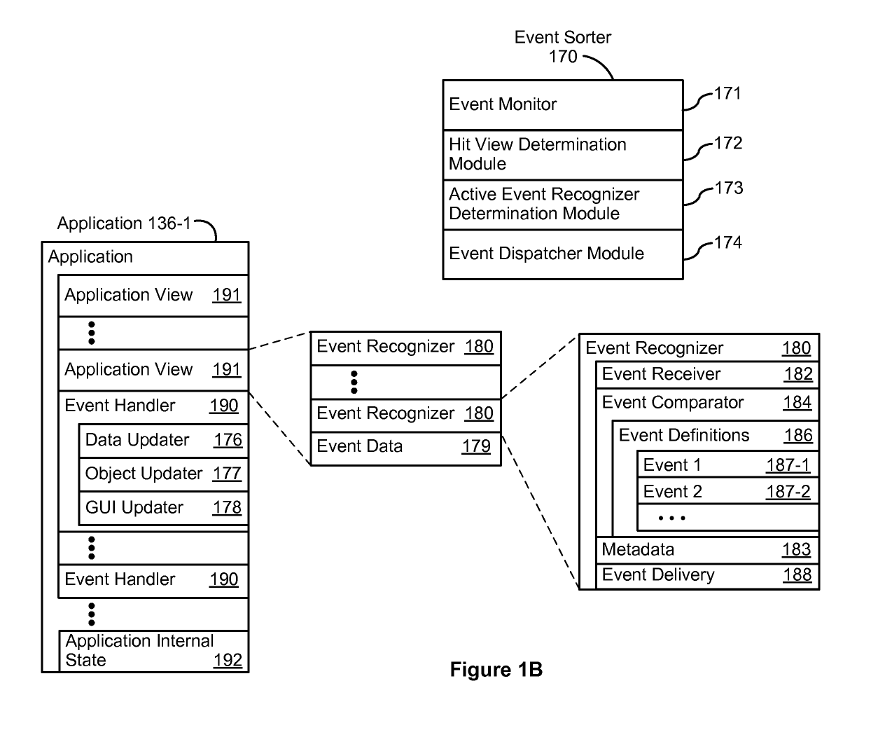

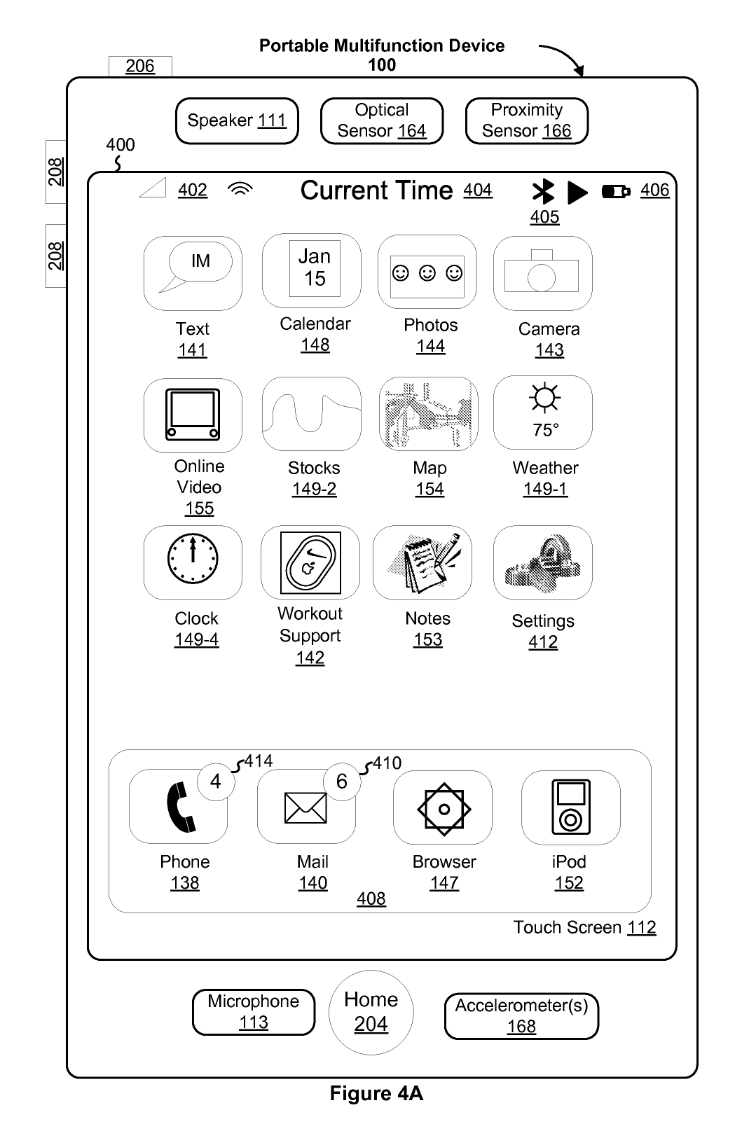

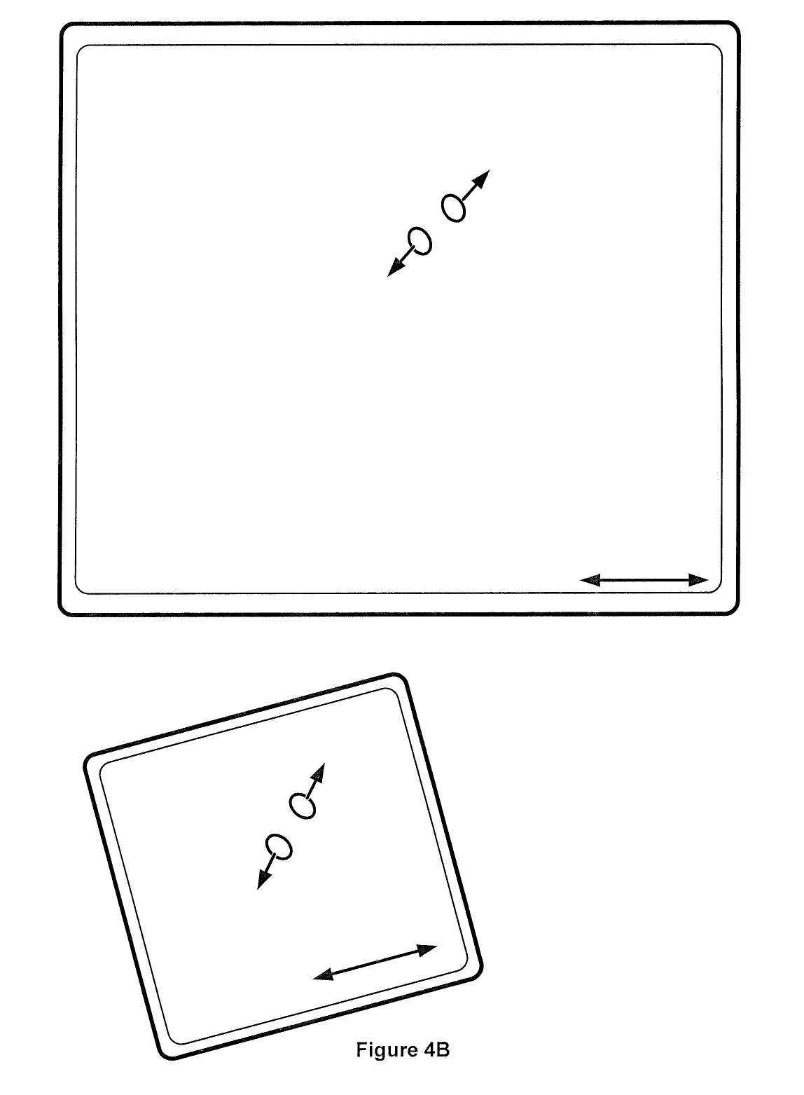

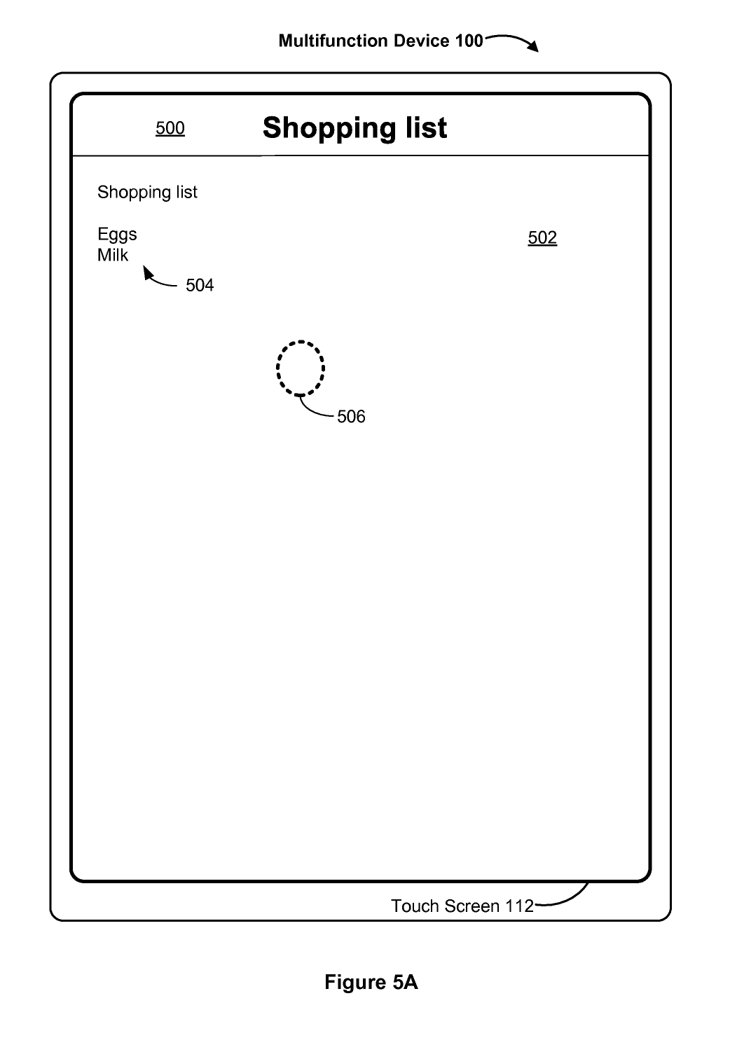

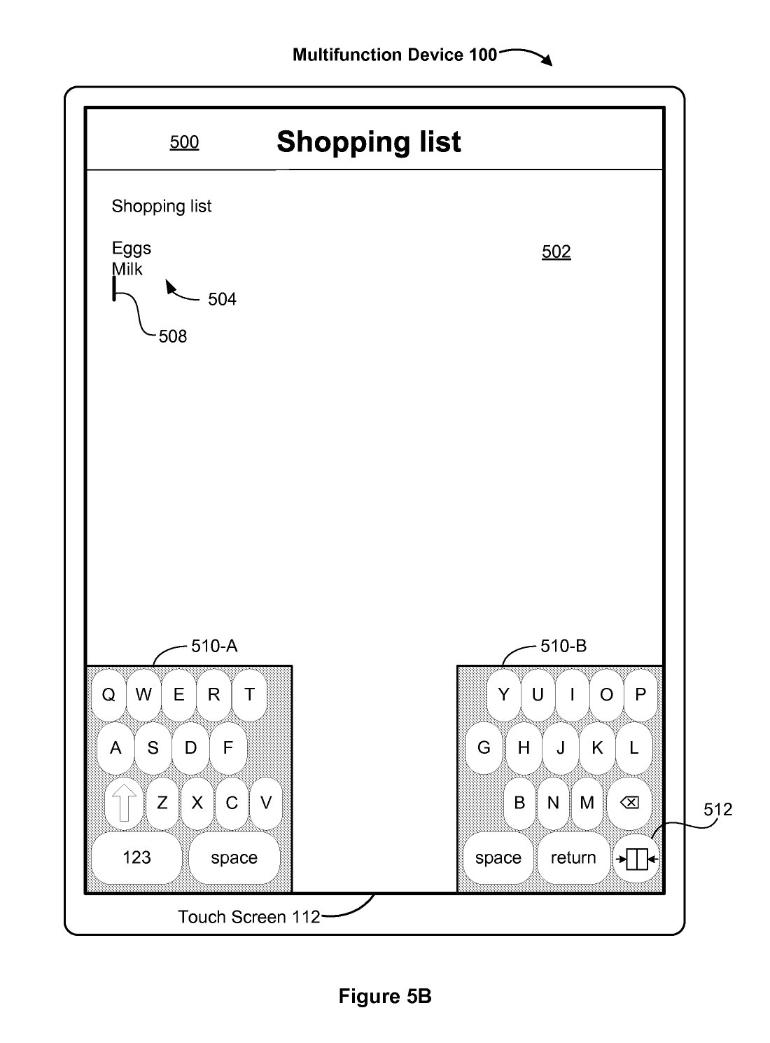

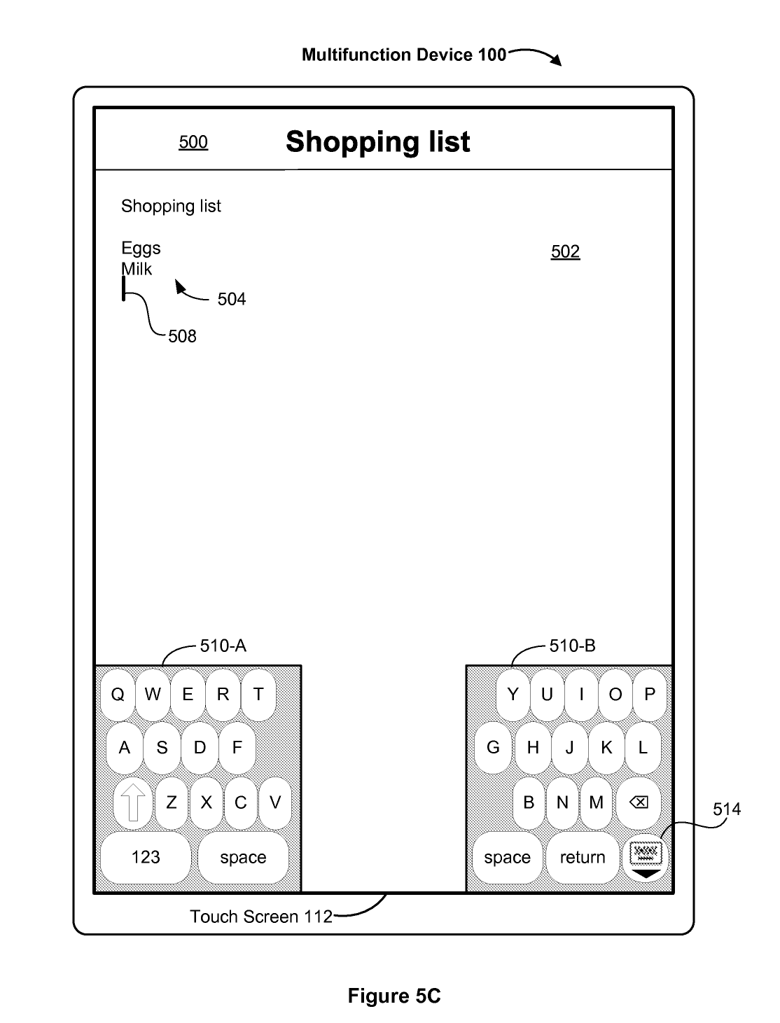

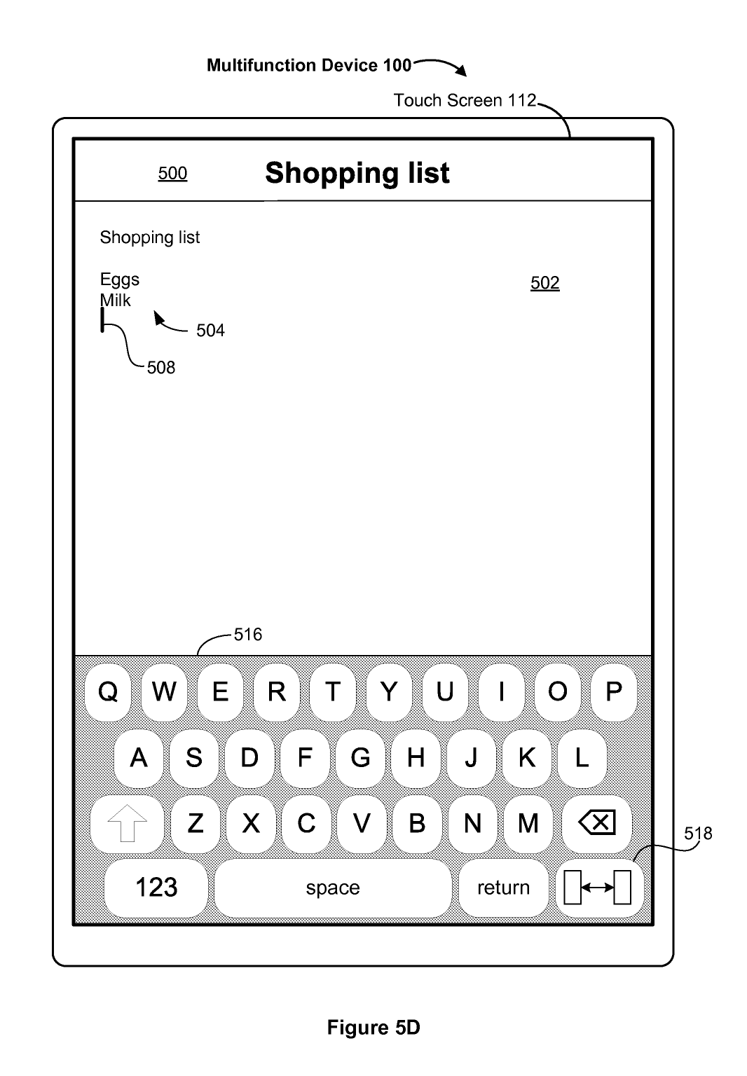

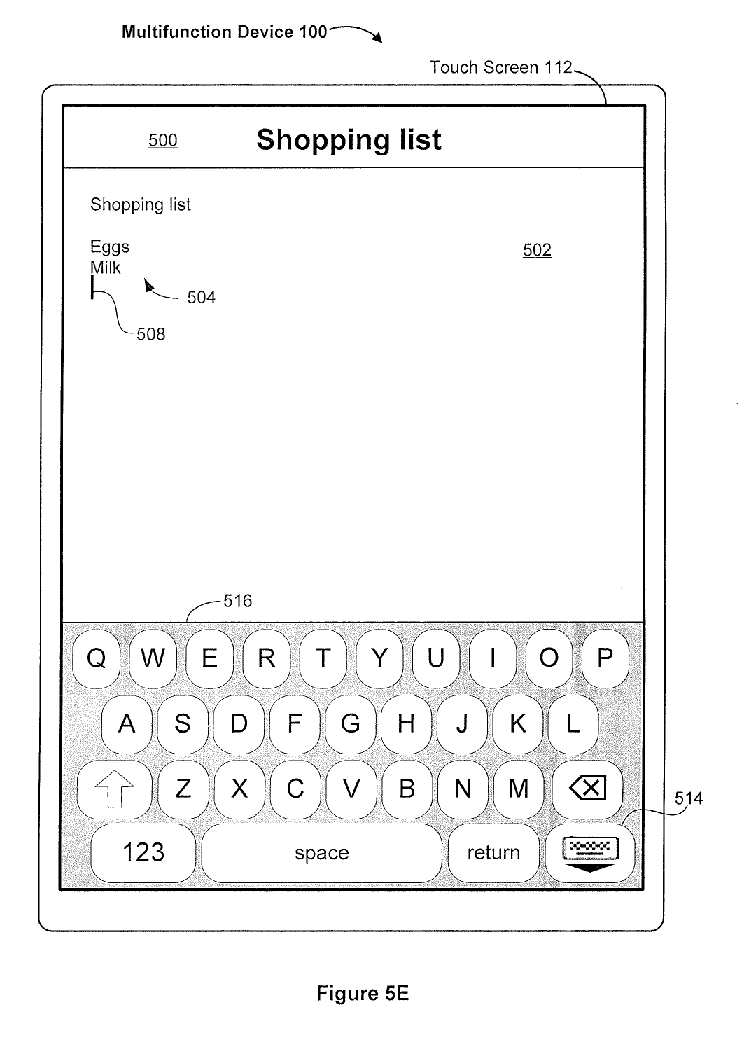

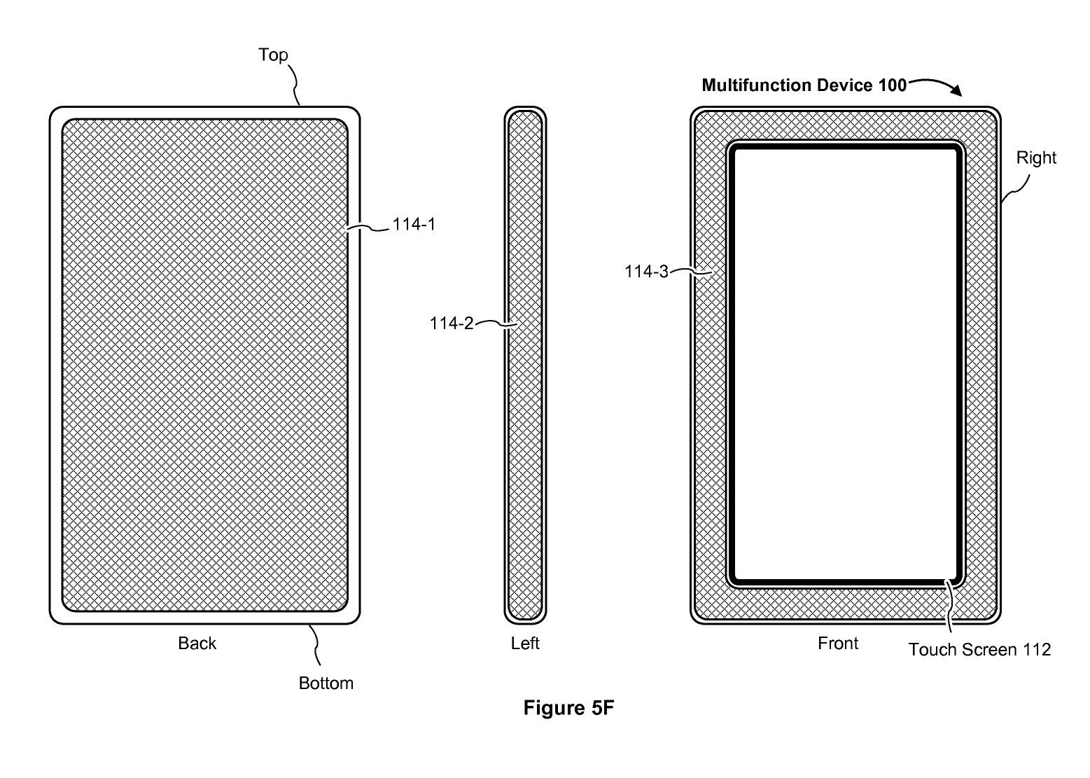

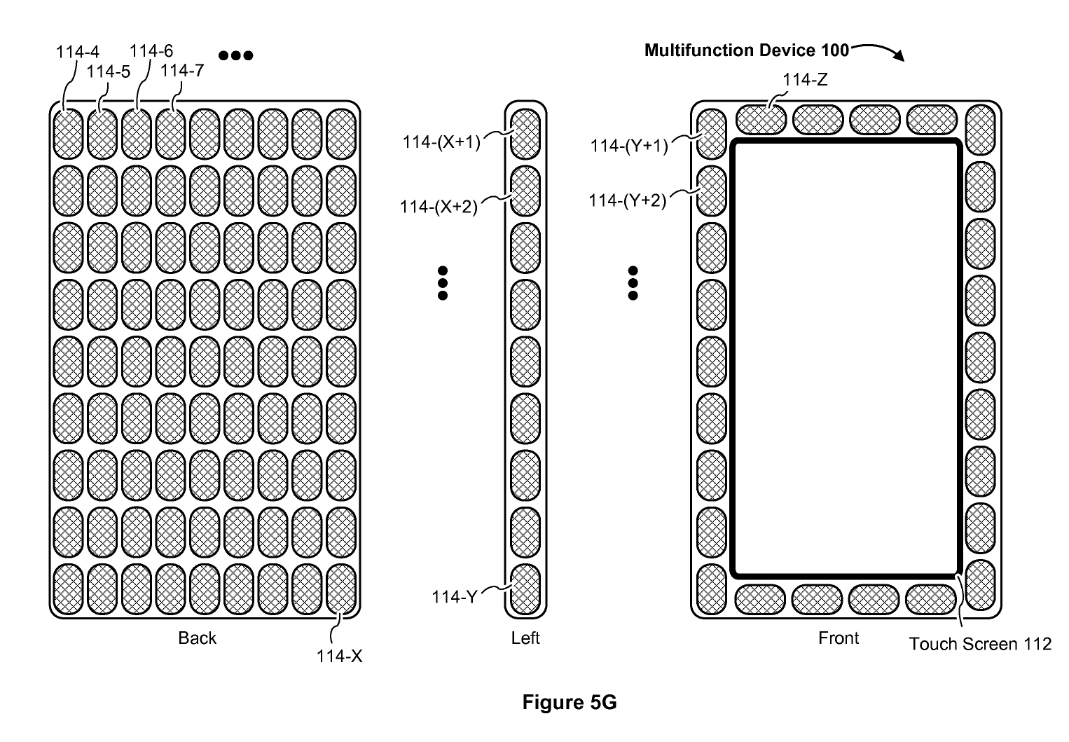

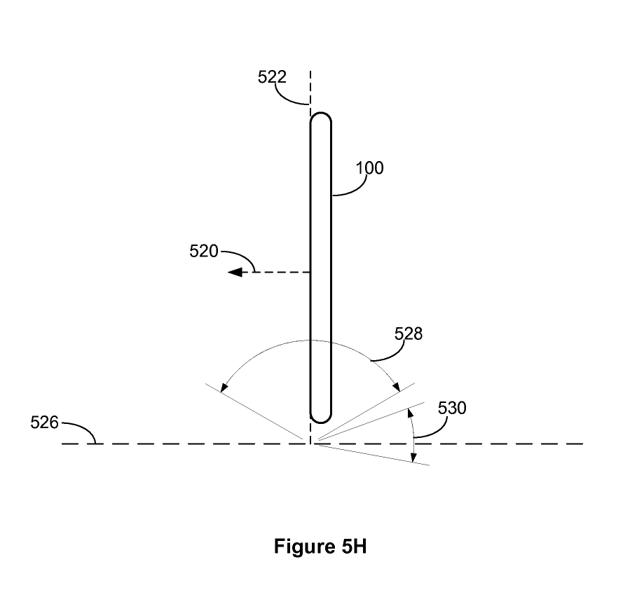

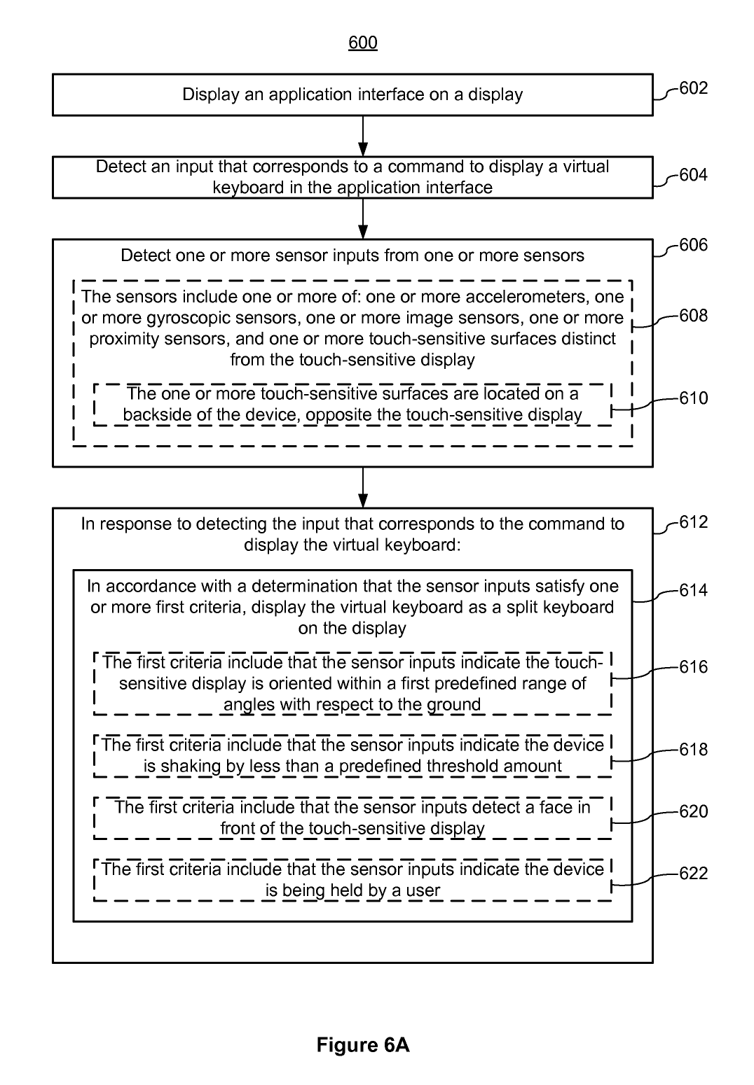

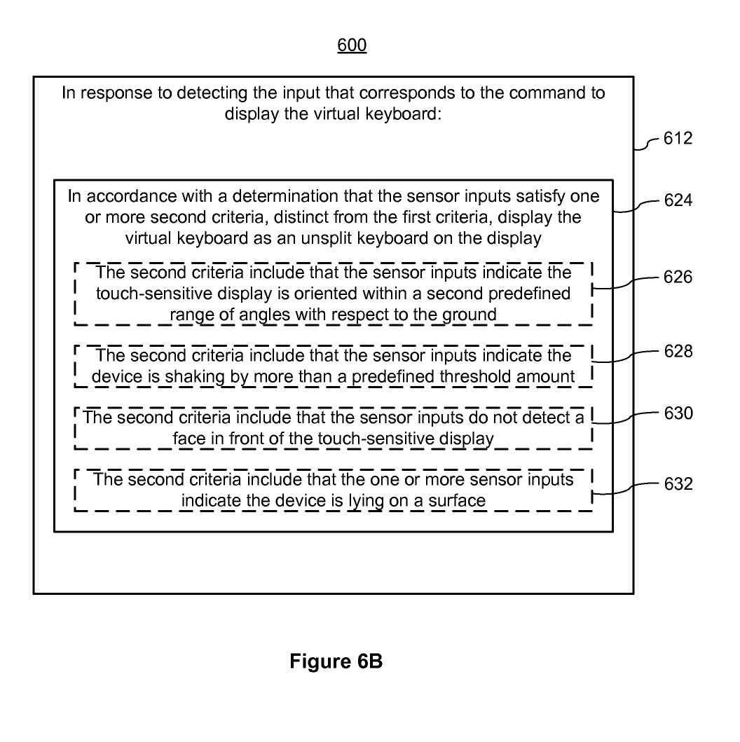

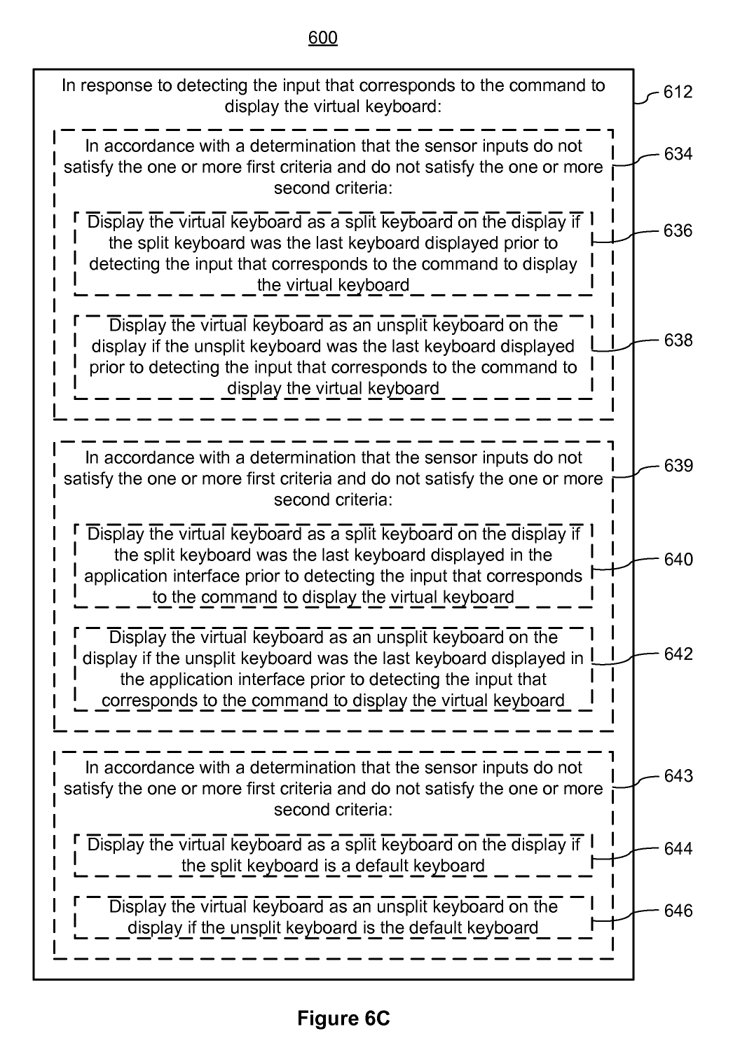

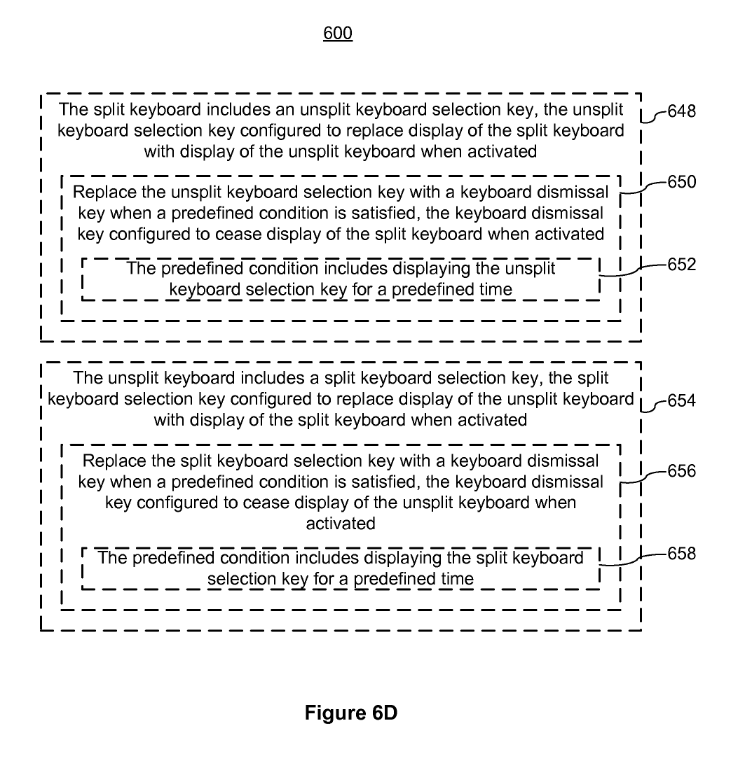

Below, FIGS. 1A-1B, 2, and 3 provide a description of exemplary devices. FIGS. 4A-4B and 5A-5H illustrate exemplary user interfaces for displaying a virtual keyboard. FIGS. 6A-6D are flow diagrams illustrating a method of displaying a virtual keyboard. The user interfaces in FIGS. 5A-5H are used to illustrate the processes in FIGS. 6A-6D.

### Exemplary Devices

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touch pads), may also be used. It should also be understood that, in some embodiments, the device is not a portable communications device, but is a desktop computer with a touch-sensitive surface (e.g., a touch screen display and/or a touch pad).

In the discussion that follows, an electronic device that includes a display and a touch-sensitive surface is described. It should be understood, however, that the electronic device may include one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive displays 112 in accordance with some embodiments. Touch-sensitive display 112 is sometimes called a “touch screen” for convenience, and may also be known as or called a touch-sensitive display system. Device 100 may include memory 102 (which may include one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Other input or control devices 116 may include one or more touch-sensitive surfaces (TSS) 114. Device 100 may include one or more optical sensors 164. These components may communicate over one or more communication buses or signal lines 103.

It should be appreciated that device 100 is only one example of a portable multifunction device, and that device 100 may have more or fewer components than shown, may combine two or more components, or may have a different configuration or arrangement of the components. The various components shown in FIG. 1A may be implemented in hardware, software, or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of device 100, such as CPU 120 and the peripherals interface 118, may be controlled by memory controller 122.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 may be implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

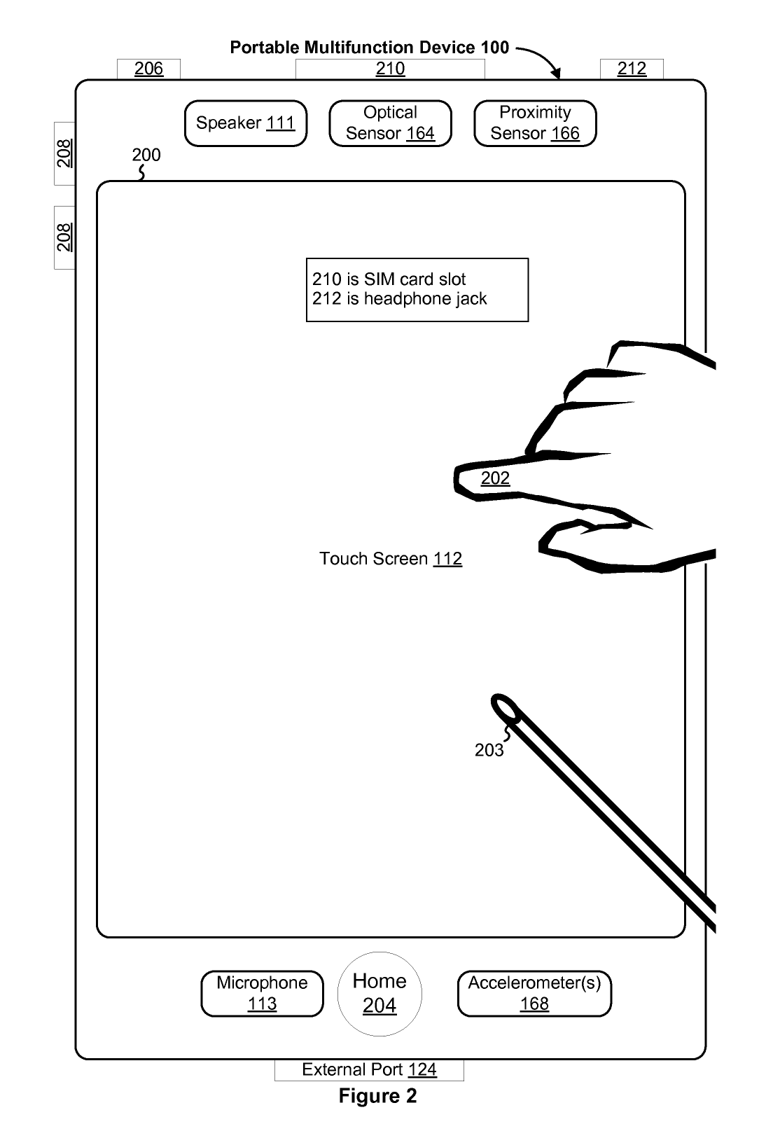

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 may include display controller 156 and one or more input controllers 160 for other input or control devices. The one or more input controllers 160 receive/send electrical signals from/to other input or control devices 116. The other input control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of speaker 111 and/or microphone 113. The one or more buttons may include a push button (e.g., 206, FIG. 2).

Touch-sensitive display 112 provides an input interface and an output interface between the device and a user. Display controller 156 receives and/or sends electrical signals from/to touch screen 112. Touch screen 112 displays visual output to the user. The visual output may include graphics, text, icons, video, and any combination thereof (collectively termed “graphics”). In some embodiments, some or all of the visual output may correspond to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 may use LCD (liquid crystal display) technology, LPD (light emitting polymer display) technology, or LED (light emitting diode) technology, although other display technologies may be used in other embodiments. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, Calif.

Touch screen 112 may have a video resolution in excess of 100 dpi. In some embodiments, the touch screen has a video resolution of approximately 160 dpi. The user may make contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 may include a touchpad (not shown) for activating or deactivating particular functions and/or one or more touch-sensitive surfaces (TSS) 114 distinct from the touch screen. In some embodiments, the touchpad or TSS 114 is a touch-sensitive area of the device that, unlike the touch screen, does not display visual output. The touchpad or TSS 114 may be a touch-sensitive surface that is separate from touch screen 112 or an extension of the touch-sensitive surface formed by the touch screen. TSS 114 may be located on a backside of device 100, opposite of the touch screen.

Device 100 also includes power system 162 for powering the various components. Power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIG. 1A shows an optical sensor coupled to optical sensor controller 158 in I/O subsystem 106. Optical sensor 164 may include charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 may capture still images or video. In some embodiments, an optical sensor is located on the back of device 100, opposite touch screen display 112 on the front of the device, so that the touch screen display may be used as a viewfinder for still and/or video image acquisition. In some embodiments, another optical sensor is located on the front of the device so that the user's image may be obtained for videoconferencing while the user views the other video conference participants on the touch screen display.

Device 100 may also include one or more proximity sensors 166. FIG. 1A shows proximity sensor 166 coupled to peripherals interface 118. Alternately, proximity sensor 166 may be coupled to input controller 160 in I/O subsystem 106. In some embodiments, the proximity sensor turns off and disables touch screen 112 when the multifunction device is placed near the user's ear (e.g., when the user is making a phone call).

Device 100 may also include one or more accelerometers 168. FIG. 1A shows accelerometer 168 coupled to peripherals interface 118. Alternately, accelerometer 168 may be coupled to an input controller 160 in I/O subsystem 106. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

Device 100 may also include one or more gyroscopic sensors 169. FIG. 1A shows gyroscopic sensor(s) 169 coupled to peripherals interface 118. Alternately, gyroscopic sensor(s) 169 may be coupled to input controller 160 in I/O subsystem 106. In some embodiments, orientation and/or rotation of device 100 is determined based on an analysis of data received from the one or more gyroscopic sensors.

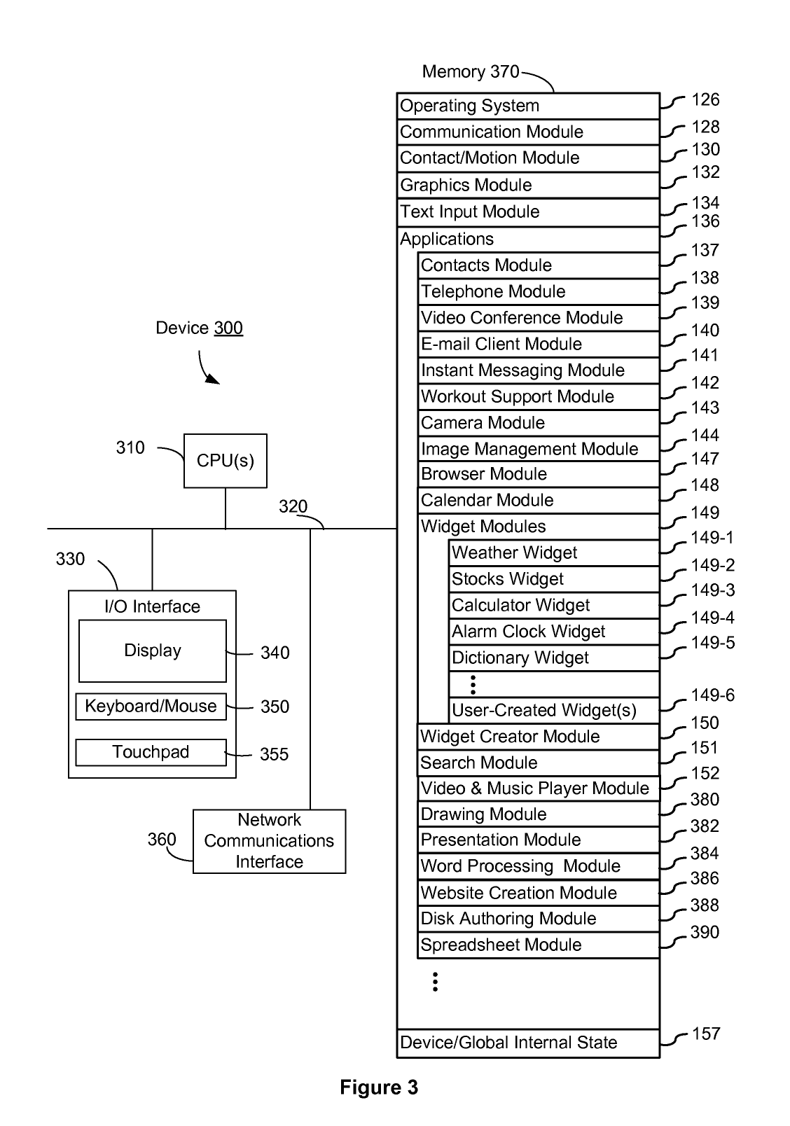

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 may detect contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, contact/motion module 130 and display controller 156 detect contact on a touchpad.

Contact/motion module 130 may detect a gesture input by a user. Different gestures on the touch-sensitive surface have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the intensity of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic may be assigned a corresponding code. Graphics module 132 receives, from applications etc., one or more codes specifying graphics to be displayed along with, if necessary, coordinate data and other graphic property data, and then generates screen image data to output to display controller 156.

Text input module 134, which may be a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 may include the following modules (or sets of instructions), or a subset or superset thereof:
contacts module 137 (sometimes called an address book or contact list);
telephone module 138; video conferencing module 139;
e-mail client module 140;
instant messaging (IM) module 141;
workout support module 142;
camera module 143 for still and/or video images;
image management module 144;
browser module 147;
calendar module 148;
widget modules 149, which may include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which may be made up of a video player module and a music player module;
notes module 153;
map module 154; and/or
online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, contacts module 137 may be used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, telephone module 138 may be used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch screen 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display system controller 156, contact module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch screen 112 or on an external, connected display via external port 124). In some embodiments, device 100 may include the functionality of an MP3 player, such as an iPod (trademark of Apple Inc.).

In conjunction with touch screen 112, display controller 156, contact module 130, graphics module 132, and text input module 134, notes module 153 includes executable instructions to create and manage notes, to do lists, and the like in accordance with user instructions.

In conjunction with RF circuitry 108, touch screen 112, display system controller 156, contact module 130, graphics module 132, text input module 134, GPS module 135, and browser module 147, map module 154 may be used to receive, display, modify, and store maps and data associated with maps (e.g., driving directions; data on stores and other points of interest at or near a particular location; and other location-based data) in accordance with user instructions.

In conjunction with touch screen 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. In some embodiments, memory 102 may store a subset of the modules and data structures identified above. Furthermore, memory 102 may store additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 may be reduced.

The predefined set of functions that may be performed exclusively through a touch screen and/or a touchpad include navigation between user interfaces. In some embodiments, the touchpad, when touched by the user, navigates device 100 to a main, home, or root menu from any user interface that may be displayed on device 100. In such embodiments, the touchpad may be referred to as a “menu button.” In some other embodiments, the menu button may be a physical push button or other physical input control device instead of a touchpad.

FIG. 1B is a block diagram illustrating exemplary components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, gyroscopic sensor(s) 169, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected may correspond to programmatic levels within a programmatic or view hierarchy of the application. For example, the lowest level view in which a touch is detected may be called the hit view, and the set of events that are recognized as proper inputs may be determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 may utilize or call data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which may include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch the event information may also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers may interact with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens, e.g., coordinating mouse movement and mouse button presses with or without single or multiple keyboard presses or holds, user movements taps, drags, scrolls, etc., on touch-pads, pen stylus inputs, movement of the device, oral instructions, detected eye movements, biometric inputs, and/or any combination thereof, which may be utilized as inputs corresponding to sub-events which define an event to be recognized.

FIG. 2 illustrates a portable multifunction device 100 having a touch screen 112 in accordance with some embodiments. The touch screen may display one or more graphics within user interface (UI) 200. In this embodiment, as well as others described below, a user may select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture may include one or more taps, one or more swipes (from left to right, right to left, upward and/or downward) and/or a rolling of a finger (from right to left, left to right, upward and/or downward) that has made contact with device 100. In some embodiments, inadvertent contact with a graphic may not select the graphic. For example, a swipe gesture that sweeps over an application icon may not select the corresponding application when the gesture corresponding to selection is a tap.

Device 100 may also include one or more physical buttons, such as “home” or menu button 204. As described previously, menu button 204 may be used to navigate to any application 136 in a set of applications that may be executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also may accept verbal input for activation or deactivation of some functions through microphone 113.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 may include circuitry (sometimes called a chipset) that interconnects and controls communications between system components. Device 300 includes input/output (I/O) interface 330 comprising display 340, which is typically a touch screen display. I/O interface 330 also may include a keyboard and/or mouse (or other pointing device) 350 and touchpad 355. Memory 370 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 370 may optionally include one or more storage devices remotely located from CPU(s) 310. In some embodiments, memory 370 stores programs, modules, and data structures analogous to the programs, modules, and data structures stored in memory 102 of portable multifunction device 100 (FIG. 1), or a subset thereof. Furthermore, memory 370 may store additional programs, modules, and data structures not present in memory 102 of portable multifunction device 100. For example, memory 370 of device 300 may store drawing module 380, presentation module 382, word processing module 384, website creation module 386, disk authoring module 388, and/or spreadsheet module 390, while memory 102 of portable multifunction device 100 (FIG. 1) may not store these modules.

Each of the above identified elements in FIG. 3 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 370 may store a subset of the modules and data structures identified above. Furthermore, memory 370 may store additional modules and data structures not described above.

Attention is now directed towards embodiments of user interfaces (“UI”) that may be implemented on portable multifunction device 100.

FIG. 4A illustrates an exemplary user interface for a menu of applications on portable multifunction device 100 in accordance with some embodiments. Similar user interfaces may be implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Phone 138, which may include an indicator 414 of the number of missed calls or voicemail messages;
   E-mail client 140, which may include an indicator 410 of the number of unread e-mails;
   Browser 147; and
   Video and music player 152, also referred to as iPod (trademark of Apple Inc.) module 152; and
Icons for other applications, such as:
   IM 141;
   Image management 144;
   Camera 143;
   Weather 149-1;
   Stocks 149-2;
   Workout support 142;
   Calendar 148;
   Alarm clock 149-4;
   Map 154;
   Notes 153;
   Settings 412, which provides access to settings for device 100 and its various applications 136; and
   Online video module 155, also referred to as YouTube (trademark of Google Inc.) module 155.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a stylus input). For example, a swipe gesture may be performed with a stylus instead of a finger.

### User Interfaces and Associated Processes

Attention is now directed towards embodiments of user interfaces (“UI”) and associated processes that may be implemented on an electronic device with a touch-sensitive display and one or more sensors, such as device 300 or portable multifunction device 100.

FIGS. 5A-5H illustrate exemplary user interfaces for displaying a virtual keyboard in accordance with some embodiments. The user interfaces in these figures are used to illustrate the processes described below, including the processes in FIGS. 6A-6D.

FIG. 5A illustrates user interface 500 displayed on touch screen 112 of device 100. User interface 500 may be a user interface for an application. As shown in FIG. 5A, user interface 500 is a user interface for a notes application in which a note titled “Shopping list” is being displayed.

User interface 500 includes text entry area 502. Text may be displayed in text entry area 502 for viewing and editing. For example, as shown in FIG. 5A, text 504 for the note “Shopping list” is displayed in text entry area 502, and the title for the note “Shopping list” is derived from the first line of text in text 504. Also, text may be input into text entry area 502. For example, additional text may be input to add to text 504.

When the user wishes to enter text into the note “Shopping list,” the user may make an input on device 100 to bring up a virtual keyboard; the input (hereinafter “keyboard display input”) corresponds to a command to display a virtual keyboard. In some embodiments, the input that corresponds to the command to display a virtual keyboard is a gesture (e.g., a tap gesture), such as gesture 506, on touch screen 112 in text entry area 502, as shown in FIG. 5A. In response to detection of gesture 506, a split virtual keyboard (hereinafter “split keyboard”) or an unsplit virtual keyboard (hereinafter “unsplit keyboard”) is displayed, as described below.

Device 100 also detects one or more sensor inputs from one or more sensors in device 100. In some embodiments, sensors included in device 100 include one or more accelerometers 168, one or more gyroscopic sensors 169, one or more optical or image sensors 164 (e.g., a camera), one or more proximity sensors 166, and one or more touch-sensitive surfaces 114 distinct from the touch-sensitive display. The sensor inputs from the one or more sensors may be, for example, data from the sensors.

The sensor inputs may satisfy a first set of one or more criteria (hereinafter “first criteria), a second set of one or more criteria (hereinafter “second criteria”), or neither the first criteria nor the second criteria. Depending on whether the sensor inputs (e.g., as of when tap gesture 506 is detected) satisfy the first criteria or the second criteria, split keyboard 510 (FIG. 5B) or unsplit keyboard 516 (FIG. 5D) is displayed in response to detection, by device 100, of gesture 506.

FIG. 5B shows split keyboard 510 displayed in text entry area 502 in response to detection of gesture 506. Split keyboard 510 includes left keyboard portion 510-A and right keyboard portion 510-B. Left keyboard portion 510-A includes a subset of the keys of split keyboard 510, and right keyboard portion 510-B includes the remainder of the keys of split keyboard 510. Cursor 508 is also displayed in text entry area, indicating that device 100 is ready to receive user input for text entry on split keyboard 510.

Split keyboard 510 may be displayed, in response to detection of gesture 506, in accordance with a determination that the sensor inputs satisfy the first criteria. In some embodiments, the first criteria include one or more of: that the sensor inputs indicate touch screen 112 is oriented within a first predefined range of angles with respect to the ground, that the sensor inputs indicate device 100 is shaking by less than a predefined threshold amount, that the sensor inputs detect a face in front of touch screen 112, and/or that the sensor inputs indicate device 100 is being held by a user.

Split keyboard 510 may also include unsplit keyboard selection key 512. In response to activation of unsplit keyboard selection key 512, split keyboard 510 is replaced on touch screen 112 with unsplit keyboard 516 (FIG. 5D). Unsplit keyboard selection key 512 may be activated in response to detection of a gesture (e.g., a tap gesture) on unsplit keyboard selection key 512.

In some embodiments, unsplit keyboard selection key 512 is replaced with keyboard dismissal key 514 when a predefined condition is satisfied, as shown in FIG. 5C. In response to activation of keyboard dismissal key 514, split keyboard 510 ceases to be displayed, as in FIG. 5A. Keyboard dismissal key 514 may be activated in response to detection of a gesture (e.g., a tap gesture) on keyboard dismissal key 514.

In some embodiments, the predefined condition for replacing unsplit keyboard selection key 512 with keyboard dismissal key 514 is that unsplit keyboard selection key 512 has been displayed on touch screen 112 for a predefined amount of time (e.g., 2, 5, or 10 seconds). For example, unsplit keyboard selection key 512, when displayed for at least the predefined amount of time, is replaced by keyboard dismissal key 514. At the next time unsplit keyboard selection key 512 is displayed, unsplit keyboard selection key 512 is replaced by keyboard dismissal key 514 when unsplit keyboard selection key 512 has been displayed for at least the predefined amount of time.

FIG. 5D shows unsplit keyboard 516 displayed in text entry area 502 in response to detection of gesture 506. Cursor 508 is also displayed in text entry area, indicating that device 100 is ready to receive user input for text entry on unsplit keyboard 516.

Unsplit keyboard 516 may be displayed, in response to detection of gesture 506, in accordance with a determination that the sensor inputs satisfy the second criteria. In some embodiments, the second criteria include one or more of: that the sensor inputs indicate touch screen 112 is oriented within a second predefined range of angles with respect to the ground, that the sensor inputs indicate device 100 is shaking by more than the predefined threshold amount, that the sensor inputs do not detect a face in front of touch screen 112, and/or that the sensor inputs indicate device 100 is lying on a surface.

Unsplit keyboard 516 may also include split keyboard selection key 518. In response to activation of split keyboard selection key 518, unsplit keyboard 516 is replaced on touch screen 112 with split keyboard 518 (FIG. 5B). Split keyboard selection key 518 may be activated in response to detection of a gesture (e.g., a tap gesture) on split keyboard selection key 518.

In some embodiments, split keyboard selection key 518 is replaced with keyboard dismissal key 514 when a predefined condition is satisfied. In response to activation of keyboard dismissal key 514, unsplit keyboard 516 ceases to be displayed, as in FIG. 5A. Keyboard dismissal key 514 may be activated in response to detection of a gesture (e.g., a tap gesture) on keyboard dismissal key 514.

In some embodiments, the predefined condition for replacing split keyboard selection key 518 with keyboard dismissal key 514 is that split keyboard selection key 518 has been displayed on touch screen 112 for a predefined amount of time (e.g., 2, 5, or 10 seconds). For example, split keyboard selection key 518, when displayed for at least the predefined amount of time, is replaced by keyboard dismissal key 514. At the next time split keyboard selection key 518 is displayed, split keyboard selection key 518 is replaced by keyboard dismissal key 514 when split keyboard selection key 518 has been displayed for at least the predefined amount of time.

As described above, the first criteria may include that the sensor inputs indicate touch screen 112 is oriented within the first predefined range of angles with respect to the ground, and the second criteria may include that the sensor inputs indicate touch screen 112 is oriented within the second predefined range of angles with respect to the ground. Sensor inputs from, for example, gyroscopic sensor(s) 169 and/or accelerometer(s) 168 may be used to determine the orientation angle of touch screen 112. FIG. 5H illustrates device 100 upright and viewed from the side, with line 522 representing the plane of the surface of touch screen 112 and direction 520 representing the direction touch screen 112 is facing. Line 526 represents a plane parallel to the ground, or more generally the horizontal. Angle range 528 represents an example of the first predefined range of angles at which touch screen 112, represented by line 522, may be oriented with respect to line 526, satisfying the first criteria. Range 528 represents a range of angles where device 100 is likely to be held by two hands. Range 528 includes the angle where touch screen 112 is upright.

Angle range 530 represents an example of the second predefined range of angles at which touch screen 112, represented by line 522, may be oriented with respect to line 526, satisfying the second criteria. Range 530 represents a range of angles where device 100 is likely to be lying on a surface. Range 530 includes the angle where touch screen 112 is facing upwards and parallel to the ground.

As described above, the first criteria may include that the sensor inputs indicate touch screen 112 is shaking by less than a predefined threshold amount, and the second criteria may include that the sensor inputs indicate touch screen 112 is shaking by more than a predefined threshold amount. Sensor inputs from, for example, accelerometer(s) 168 may be used to determine the amount of shaking Shaking more the predefined threshold amount indicates that device 100 is vibrating, shaking, or is otherwise moving about (e.g., device 100 is being held with unsteady hands, or device 100 is being used in a moving vehicle).

As described above, the first criteria may include that the sensor inputs detect a face in front of touch screen 112 (e.g., direction 520 (FIG. 5H) points toward a face), and the second criteria may include that the sensor inputs do not detect a face in front of touch screen 112. Sensor inputs from, for example, optical sensor(s) 164 and/or proximity sensor 166 may be used to detect a face. Detection of a face in front of touch screen 112 indicates that device 100 is more likely being held with both hands, with the user looking directly at touch screen 112. Non-detection of a face in front of touch screen 112 indicates that device 100 is more likely lying on a surface.

As described above, the first criteria may include that the sensor inputs indicate device 100 is being held by a user, and the second criteria may include that the sensor inputs indicate device 100 is lying on a surface. Sensor inputs from, for example, optical sensor(s) 164, proximity sensor 166, accelerometer(s) 168, gyroscopic sensor(s) 169, and TSS 114 may be used to determine whether device 100 is being held by a user or lying on a surface. For example, TSS 114 located on the backside and/or sides of device 100 may detect hand or finger contacts on the side or backside of device 100, indicating that device 100 is being held by hand.

FIGS. 5F and 5G illustrate portable multifunction devices having touch-sensitive displays and touch-sensitive surfaces (TSS) 114 that are distinct from the touch-sensitive displays in accordance with some embodiments.

FIG. 5F depicts that portable multifunction device 100 has touch-sensitive surfaces on its back (e.g., 114-1), sides (e.g., left 114-2, right (not shown), top (not shown), and bottom (not shown)), and front bezel (e.g., 114-3). In some embodiments, touch-sensitive surfaces 114 are integrated (e.g., touch-sensitive surfaces 114 on its back, sides, and front bezel are an extension of a single touch-sensitive surface). In some embodiments, touch-sensitive surfaces 114 include distinct touch-sensitive surfaces on different areas (e.g., back, sides, and front bezel) of device 100. In some embodiments, device 100 includes a subset of, but not all, touch-sensitive surfaces depicted in FIG. 5F. For example, device 100 may include touch-sensitive surfaces on its back and front bezel, but not on its sides. Alternatively, device 100 may include one or more touch-sensitive surfaces on its front bezel and sides, but not on its back; on its sides and back, but not on its front bezel; on its front bezel only, but not on its sides or back; on its sides only, but not on its front bezel or back; or on its back only, but not on its front bezel and sides. In some embodiments, device 100 includes touch-sensitive surfaces on one of: the back side, the four sides, and the front bezel of device 100. In some embodiments, the device has distinct touch-sensitive surfaces for four sides (top, bottom, left, and right). In some embodiments, the device may have a single continuous touch-sensitive surface for four sides. In some embodiments, the device has distinct touch-sensitive surfaces for two sides (e.g., left and right).

FIG. 5G depicts that portable multifunction device 100 has a plurality of touch-sensitive surfaces 114 on its back (e.g., 114-4 through 114-X), sides (e.g., 114-(X+1) through 114-Y and additional touch-sensitive surfaces on right, top, and bottom sides (not shown)), and front bezel (e.g., 114-(Y+1) through 114-Z). The plurality of touch-sensitive surfaces 114 may be arranged in a pattern (e.g., a grid pattern as depicted in FIG. 5G, a honeycomb pattern, a spiral pattern, etc.). In some embodiments, a combination of two or more patterns is used (e.g., a respective pattern is used for a respective area of device 100).

In some embodiments, device 100 includes a subset of, but not all, touch-sensitive surfaces depicted in FIG. 5G.

In some embodiments, the plurality of touch-sensitive surfaces 114 is not uniformly distributed. In some embodiments, the plurality of touch-sensitive surfaces 114 on the back of device 100 is more densely positioned along the edges than near the center, or vice versa (not shown). In some embodiments, the plurality of touch-sensitive surfaces 114 on the back of device 100 is positioned along the edges (e.g., touch-sensitive surfaces are not located near the center of the back side of device 100 (not shown)).

In some embodiments, the plurality of touch-sensitive surfaces 114 on respective sides (e.g., 114-2 on the left side) of device 100 is not uniformly distributed. In some embodiments, the plurality of touch-sensitive surfaces 114 on respective sides (e.g., left and/or right side) of device 100 is more densely located near the middle than toward the top and bottom of device 100. In some embodiments, the plurality of touch-sensitive surfaces 114 on respective sides (e.g., left and/or right side) of device 100 is located near the middle and not toward the top and bottom of device 100.

In some embodiments, the plurality of touch-sensitive surfaces 114 on the front bezel of device 100 is not uniformly distributed. In some embodiments, the plurality of touch-sensitive surfaces 114 on the front bezel of device 100 is more densely located near the sides than near the top and bottom of device 100. In some embodiments, the plurality of touch-sensitive surfaces 114 on the front bezel is located along the sides and not along the top and bottom of device 100.

It may be the case that the sensor inputs do not satisfy the first criteria and do not satisfy the second criteria. For example, the sensor inputs may be inconclusive, ambiguous, or contradictory with respect to whether the sensor inputs indicate that device 100 is being held by hand or lying on a surface (e.g., a table top). In some embodiments, split keyboard 510 is displayed in response to detection of gesture 506 (as in FIG. 5B), in accordance with a determination that the sensor inputs do not satisfy the first criteria and do not satisfy the second criteria if: split keyboard 510 was the last virtual keyboard displayed prior to detection of gesture 506, split keyboard 510 was the last virtual keyboard displayed in user interface 500 prior to detection of gesture 506, or split keyboard 510 is the default virtual keyboard.

In some embodiments, unsplit keyboard 516 is displayed in response to detection of gesture 506 (as shown in FIG. 5D), in accordance with a determination that the sensor inputs do not satisfy the first criteria and do not satisfy the second criteria if: unsplit keyboard 516 was the last virtual keyboard displayed prior to detection of gesture 506, unsplit keyboard 516 was the last virtual keyboard displayed in user interface 500 prior to detection of gesture 506, or unsplit keyboard 516 is the default virtual keyboard.

FIGS. 6A-6D are flow diagrams illustrating a method 600 of displaying a virtual keyboard in accordance with some embodiments. The method 600 is performed at an electronic device (e.g., device 300, FIG. 3, or portable multifunction device 100, FIG. 1) with a display and a touch-sensitive surface and one or more sensors. In some embodiments, the display is a touch screen display and the touch-sensitive surface is on the display, and the sensors are distinct from the touch sensitive display. In some embodiments, the display is separate from the touch-sensitive surface. Some operations in method 600 may be combined and/or the order of some operations may be changed.

As described below, the method 600 provides a way to automatically display the soft keyboard that is best suited to how the device is being held or supported. The method reduces the cognitive burden on a user when using virtual keyboards, thereby creating a more efficient human-machine interface. For battery-operated electronic devices, enabling a user to use an optimum virtual keyboard faster and more efficiently conserves power and increases the time between battery charges.

The device displays (602) an application interface on the display. For example, FIG. 5A shows user interface 500 for a notes application displayed on touch screen 112.

The device detects (604) an input that corresponds to a command to display a virtual keyboard in the application interface (e.g., a tap gesture on a text input area in the application interface, or other appropriate finger gesture on the touch-sensitive display). FIG. 5A shows gesture 506 detected on touch screen 112, in user interface 500, while a virtual keyboard is not displayed.

The device detects (606) one or more sensor inputs from the one or more sensors (e.g., detecting inputs from one type of sensor or concurrently from two or more distinct types of sensors). The sensor inputs, for example, may be data from the sensors.

In some embodiments, the sensors include one or more of: one or more accelerometers, one or more gyroscopic sensors, one or more image sensors (e.g., a camera), one or more proximity sensors, and one or more touch-sensitive surfaces distinct from the touch-sensitive display (608). For example, device 100, as shown in FIG. 1A, may include accelerometer(s) 168, gyroscopic sensor(s) 169, optical sensor(s) 164, proximity sensor 166, and TSS 114. Device 100 may also include other types of sensors (not shown).

In some embodiments, the one or more touch-sensitive surfaces are located on a backside of the device, opposite the touch-sensitive display (610). FIG. 5F, for examples, shows device 100 with TSS 114-1 that are located on the backside of device 100, opposite of touch screen 112. As another example, FIG. 5G shows device 100 with TSS 114-4 thru 114-X that are located on the backside of device 100, opposite of touch screen 112.

In response to detecting the input that corresponds to the command to display the virtual keyboard (612), in accordance with a determination that the sensor inputs satisfy one or more first criteria, the device displays (614) the virtual keyboard as a split keyboard on the display. In accordance with a determination that the sensor inputs satisfy one or more second criteria, distinct from the first criteria, the device displays (624) the virtual keyboard as an unsplit keyboard on the display. FIG. 5B shows split keyboard 510 displayed on touch screen 112 in response to detection of gesture 506 by device 100. Split keyboard 510 may be displayed as shown in FIG. 5B in accordance with a determination that the sensor inputs satisfy the first criteria. In contrast, FIG. 5D shows unsplit keyboard 516 displayed on touch screen 112 in response to detection of gesture 506 by device 100. Unsplit keyboard 516 may be displayed as shown in FIG. 5D in accordance with a determination that the sensor inputs satisfy the second criteria.

In some embodiments, the first criteria include that the sensor inputs indicate the touch-sensitive display is oriented within a first predefined range of angles with respect to the ground (616). In some embodiments, accelerometers and/or gyroscopes are used to determine the orientation of the touch-sensitive display with respect to the ground. For example, if these sensors indicate that the touch-sensitive display is upright, or within a predefined range of angles from being upright, with respect to the ground, then the split keyboard is displayed because the device is likely being held by a user with two hands for two-thumb typing, rather than lying on a surface for two-handed typing with fingers and thumbs. For example, accelerometer(s) 168 and gyroscopic sensor(s) 169 may be used to determine the orientation of touch screen 112, as represented by line 522 (FIG. 5H), with respect to line 526. If touch screen 112 is within angle range 528 with respect to line 526, then split keyboard 510 is displayed.

In some embodiments, the first criteria include that the sensor inputs indicate the device is shaking by less than a predefined threshold amount (618). For example, if accelerometers (e.g., accelerometer(s) 168) indicate the device is moving less than a threshold amount, then the split keyboard (e.g., split keyboard 510) is displayed.

In some embodiments, the first criteria include that the sensor inputs detect a face in front of the touch-sensitive display (620). For example, if a front-facing camera (e.g., optical sensor(s) 164) on the device detects a face, then the split keyboard (e.g., split keyboard 510) is displayed because a user may be holding the device with two hands (for two-thumb typing) and looking directly at the display.

In some embodiments, the first criteria include that the sensor inputs indicate the device is being held by a user (622). For example, if touch-sensitive surfaces (e.g., TSS 114) on the sides or backside of the device detect hand or finger contacts; a camera (e.g., optical sensor(s) 164) detects a face in front of the touch-sensitive display; and/or if inputs from accelerometers/gyroscopes (e.g., accelerometer(s) 168, gyroscopic sensor(s) 169) indicate that the touch-sensitive display is upright, or within a predefined range of angles from being upright, with respect to the ground (e.g., with angle range 528), then the split keyboard (e.g., split keyboard 510) is displayed because the device is likely being held by a user with two hands for two-thumb typing, rather than lying on a surface for two-handed typing with fingers and thumbs.

In some embodiments, the second criteria include that the sensor inputs indicate the touch-sensitive display is oriented within a second predefined range of angles with respect to the ground (626). In some embodiments, accelerometers and/or gyroscopes are used to determine the orientation of the touch-sensitive display with respect to the ground. For example, if these sensors indicate that the touch-sensitive display is parallel (flat) or within a predefined range of angles from being parallel with respect to the ground, then the unsplit keyboard is displayed because the device is likely lying on a surface for two-handed typing with fingers and thumbs, rather than being held by a user with two hands for two-thumb typing. For example, accelerometer(s) 168 and gyroscopic sensor(s) 169 may be used to determine the orientation of touch screen 112, as represented by line 522 (FIG. 5H), with respect to line 526. If touch screen 112 is within angle range 530 with respect to line 526, then unsplit keyboard 516 is displayed.

In some embodiments, the second criteria include that the sensor inputs indicate the device is shaking by more than a predefined threshold amount (628). For example, if accelerometers (e.g., accelerometer(s) 168) indicate the device is moving more than a threshold amount, then the unsplit keyboard (e.g., unsplit keyboard 516) is displayed. If the keys on the unsplit keyboard are larger than the keys on the split keyboard, it may be easier to activate the larger keys on the unsplit keyboard when the device is vibrating, shaking, or is otherwise moving about.

In some embodiments, the second criteria include that the sensor inputs do not detect a face in front of the touch-sensitive display (630). For example, if a front-facing camera (e.g., optical sensor(s) 164) on the device sees a ceiling, rather than a user's face, then the unsplit keyboard (e.g., unsplit keyboard 516) is displayed because the device is more likely to be lying on a surface, where two-handed touch typing (rather than two-thumb typing) is performed.

In some embodiments, the second criteria include that the one or more sensor inputs indicate the device is lying on a surface (632). For example, if touch-sensitive surfaces (e.g., TSS 114) on the sides or backside of the device do not detect hand or finger contacts; a camera (e.g., optical sensor(s) 164) does not detect a face in front of the touch-sensitive display; and/or if inputs from accelerometers/gyroscopes (e.g., accelerometer(s) 168, gyroscopic sensor(s) 169) indicate that the touch-sensitive display is parallel (flat), or within a predefined range of angles from being parallel, with respect to the ground (e.g., within angle range 530, FIG. 5H), then the unsplit keyboard (e.g., unsplit keyboard 516) is displayed because the device is likely lying on a surface for two-handed typing with fingers and thumbs, rather than being held by a user with two hands for two-thumb typing.

In some embodiments, in response to detecting the input that corresponds to the command to display the virtual keyboard (612), in accordance with a determination that the sensor inputs do not satisfy the one or more first criteria and do not satisfy the one or more second criteria (634), the device displays (636) the virtual keyboard as a split keyboard on the display if the split keyboard was the last keyboard displayed prior to detecting the input that corresponds to the command to display the virtual keyboard and the device displays (638) the virtual keyboard as an unsplit keyboard on the display if the unsplit keyboard was the last keyboard displayed prior to detecting the input that corresponds to the command to display the virtual keyboard. For example, if the sensor inputs satisfy neither the first criteria nor the second criteria, split keyboard 510 may be displayed in response to detection of gesture 506 if split keyboard 510 was the last virtual keyboard displayed prior to detection of gesture 506, and unsplit keyboard 516 may be displayed in response to detection of gesture 506 if unsplit keyboard 516 was the last virtual keyboard displayed prior to detection of gesture 506.

In some embodiments, in response to detecting the input that corresponds to the command to display the virtual keyboard (612), in accordance with a determination that the sensor inputs do not satisfy the one or more first criteria and do not satisfy the one or more second criteria (639), the device displays (640) the virtual keyboard as a split keyboard on the display if the split keyboard was the last keyboard displayed in the application interface prior to detecting the input that corresponds to the command to display the virtual keyboard and displays (642) the virtual keyboard as an unsplit keyboard on the display if the unsplit keyboard was the last keyboard displayed in the application interface prior to detecting the input that corresponds to the command to display the virtual keyboard. For example, if the sensor inputs satisfy neither the first criteria nor the second criteria, split keyboard 510 may be displayed in response to detection of gesture 506 if split keyboard 510 was the last virtual keyboard displayed in user interface 500 for the notes application prior to detection of gesture 506, and unsplit keyboard 516 may be displayed in response to detection of gesture 506 if unsplit keyboard 516 was the last virtual keyboard displayed in user interface 500 for the notes application prior to detection of gesture 506.

In some embodiments, in response to detecting the input that corresponds to the command to display the virtual keyboard (612), in accordance with a determination that the sensor inputs do not satisfy the one or more first criteria and do not satisfy the one or more second criteria (643), the device displays (644) the virtual keyboard as a split keyboard on the display if the split keyboard is a default keyboard and displays (646) the virtual keyboard as an unsplit keyboard on the display if the unsplit keyboard is the default keyboard. For example, if the sensor inputs satisfy neither the first criteria nor the second criteria, split keyboard 510 may be displayed in response to detection of gesture 506 if split keyboard 510 is the default keyboard, and unsplit keyboard 516 may be displayed in response to detection of gesture 506 if unsplit keyboard 516 is the default keyboard. Whether split keyboard 510 or unsplit keyboard 516 is the default keyboard may predefined and/or set by a user (e.g., via settings 412, FIG. 4A).

In some embodiments, the split keyboard includes an unsplit keyboard selection key (648). The unsplit keyboard selection key is configured to replace display of the split keyboard with display of the unsplit keyboard when activated. For example, split keyboard 510 includes unsplit keyboard selection key 512. In response to activation of unsplit keyboard activation key 512 (e.g., with a tap gesture), display of split keyboard 510 is replaced with display of unsplit keyboard 516.

In some embodiments, the device replaces (650) the unsplit keyboard selection key with a keyboard dismissal key when a predefined condition is satisfied. The keyboard dismissal key is configured to cease display of the split keyboard when activated. For example, unsplit keyboard selection key 512 is replaced with keyboard dismissal key 514 when a predefined condition is satisfied. In response to activation of keyboard dismissal key 514 in split keyboard 510 (e.g., with a tap gesture), split keyboard 510 ceases to be displayed.

In some embodiments, the predefined condition includes displaying the unsplit keyboard selection key for a predefined time (652). For example, if unsplit keyboard selection key 512 has been displayed for at least a predefined amount of time (e.g., 2, 5, or seconds), unsplit keyboard selection key 512 may be replaced with keyboard dismissal key 514, as shown in FIG. 5C.

In some embodiments, the unsplit keyboard includes a split keyboard selection key (654). The split keyboard selection key is configured to replace display of the unsplit keyboard with display of the split keyboard when activated. For example, unsplit keyboard 516 includes split keyboard selection key 518. In response to activation of split keyboard activation key 518 (e.g., with a tap gesture), display of unsplit keyboard 516 is replaced with display of split keyboard 510.

In some embodiments, the device replaces (656) the split keyboard selection key with a keyboard dismissal key when a predefined condition is satisfied. The keyboard dismissal key is configured to cease display of the unsplit keyboard when activated. For example, split keyboard selection key 518 is replaced with keyboard dismissal key 514 when a predefined condition is satisfied. In response to activation of keyboard dismissal key 514 in unsplit keyboard 516, unsplit keyboard 516 ceases to be displayed.

In some embodiments, the predefined condition includes displaying the split keyboard selection key for a predefined time (658). For example, if split keyboard selection key 518 has been displayed for at least a predefined amount of time (e.g., 2, 5, or 10 seconds), split keyboard selection key 518 may be replaced with keyboard dismissal key 514, as shown in FIG. 5E.

It should be understood that the particular order in which the operations in FIGS. 6A-6D have been described is merely exemplary and is not intended to indicate that the described order is the only order in which the operations could be performed. One of ordinary skill in the art would recognize various ways to reorder the operations described herein.

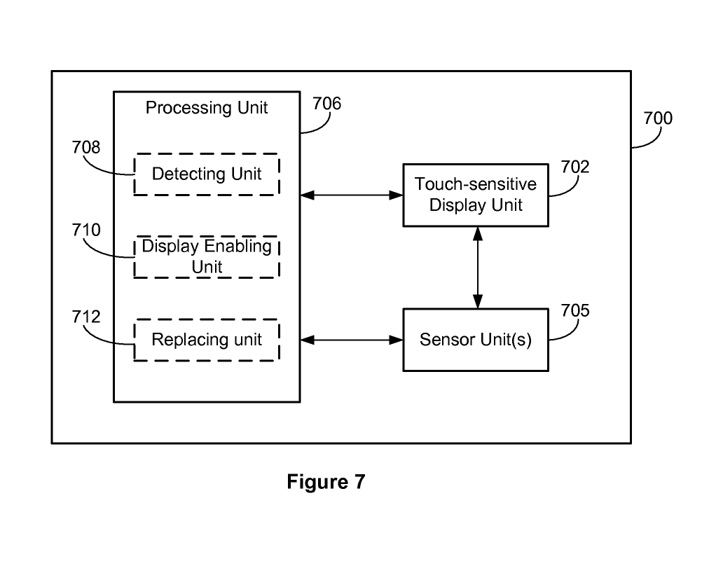

In accordance with some embodiments, FIG. 7 shows a functional block diagram of an electronic device 700 configured in accordance with the principles of the invention as described above. The functional blocks of the device may be implemented by hardware, software, or a combination of hardware and software to carry out the principles of the invention. It is understood by persons of skill in the art that the functional blocks described in FIG. 7 may be combined or separated into sub-blocks to implement the principles of the invention as described above. Therefore, the description herein may support any possible combination or separation or further definition of the functional blocks described herein.

As shown in FIG. 7, an electronic device 700 includes a touch-sensitive display unit 702 configured to display an application interface, one or more sensor units 705, and a processing unit 706 coupled to the touch-sensitive display unit 702 and the sensor units 705. In some embodiments, the processing unit 706 includes a detecting unit 708, a display enabling unit 710, and a replacing unit 712.

The processing unit 706 is configured to: detect an input that corresponds to a command to display a virtual keyboard in the application interface (e.g., with the detecting unit 708); detect one or more sensor inputs from the one or more sensor units 705 (e.g., with the detecting unit 708); in response to detecting the input that corresponds to the command to display the virtual keyboard, in accordance with a determination that the sensor inputs satisfy one or more first criteria, enable display of the virtual keyboard as a split keyboard on the touch-sensitive display unit 702 (e.g., with the display enabling unit 710), and in accordance with a determination that the sensor inputs satisfy one or more second criteria, distinct from the first criteria, enable display of the virtual keyboard as an unsplit keyboard on the touch-sensitive display unit 702 (e.g., with the display enabling unit 710).

In some embodiments, the sensor units 705 include one or more of: one or more accelerometers, one or more gyroscopic sensors, one or more image sensors, one or more proximity sensors, and one or more touch-sensitive surfaces distinct from the touch-sensitive display unit 702.

In some embodiments, the one or more touch-sensitive surfaces are located on a backside of the device, opposite the touch-sensitive display unit 702.

In some embodiments, the first criteria include that the sensor inputs indicate the touch-sensitive display unit 702 is oriented within a first predefined range of angles with respect to the ground.

In some embodiments, the first criteria include that the sensor inputs indicate the device is shaking by less than a predefined threshold amount.

In some embodiments, the first criteria include that the sensor inputs detect a face in front of the touch-sensitive display unit 702.

In some embodiments, the first criteria include that the sensor inputs indicate the device is being held by a user.

In some embodiments, the second criteria include that the sensor inputs indicate the touch-sensitive display unit 702 is oriented within a second predefined range of angles with respect to the ground.

In some embodiments, the second criteria include that the sensor inputs indicate the device is shaking by more than a predefined threshold amount.

In some embodiments, the second criteria include that the sensor inputs do not detect a face in front of the touch-sensitive display unit 702.

In some embodiments, the second criteria include that the sensor inputs indicate the device is lying on a surface.

In some embodiments, the processing unit 706 is configured to: in response to detecting the input that corresponds to the command to display the virtual keyboard, in accordance with a determination that the sensor inputs do not satisfy the one or more first criteria and do not satisfy the one or more second criteria, enable display of the virtual keyboard as a split keyboard on the touch-sensitive display unit 702 if the split keyboard was the last keyboard displayed prior to detecting the input that corresponds to the command to display the virtual keyboard (e.g., with the display enabling unit 710), and enable display of the virtual keyboard as an unsplit keyboard on the touch-sensitive display unit 702 if the unsplit keyboard was the last keyboard displayed prior to detecting the input that corresponds to the command to display the virtual keyboard (e.g., with the display enabling unit 710).

In some embodiments, the processing unit 706 is configured to: in response to detecting the input that corresponds to the command to display the virtual keyboard, in accordance with a determination that the sensor inputs do not satisfy the one or more first criteria and do not satisfy the one or more second criteria, enable display of the virtual keyboard as a split keyboard on the touch-sensitive display unit 702 if the split keyboard was the last keyboard displayed in the application interface prior to detecting the input that corresponds to the command to display the virtual keyboard (e.g., with the display enabling unit 710), and enable display of the virtual keyboard as an unsplit keyboard on the touch-sensitive display unit 702 if the unsplit keyboard was the last keyboard displayed in the application interface prior to detecting the input that corresponds to the command to display the virtual keyboard (e.g., with the display enabling unit 710).

In some embodiments, the processing unit 706 is configured to: in response to detecting the input that corresponds to the command to display the virtual keyboard, in accordance with a determination that the sensor inputs do not satisfy the one or more first criteria and do not satisfy the one or more second criteria, enable display of the virtual keyboard as a split keyboard on the touch-sensitive display unit 702 if the split keyboard is a default keyboard (e.g., with the display enabling unit 710), and enable display of the virtual keyboard as an unsplit keyboard on the touch-sensitive display unit 702 if the unsplit keyboard is the default keyboard (e.g., with the display enabling unit 710).

In some embodiments, the split keyboard includes an unsplit keyboard selection key, the unsplit keyboard selection key configured to replace display of the split keyboard with display of the unsplit keyboard when activated.

In some embodiments, the processing unit 706 is configured to replace the unsplit keyboard selection key with a keyboard dismissal key when a predefined condition is satisfied (e.g., with the replacing unit 712), the keyboard dismissal key configured to cease display of the split keyboard when activated.

In some embodiments, the predefined condition includes displaying the unsplit keyboard selection key for a predefined time.

In some embodiments, the unsplit keyboard includes a split keyboard selection key, the split keyboard selection key configured to replace display of the unsplit keyboard with display of the split keyboard when activated.

In some embodiments, the processing unit 706 is configured to replace the split keyboard selection key with a keyboard dismissal key when a predefined condition is satisfied (e.g., with the replacing unit 712), the keyboard dismissal key configured to cease display of the unsplit keyboard when activated.

In some embodiments, the predefined condition includes displaying the split keyboard selection key for a predefined time.

The operations in the information processing methods described above may be implemented by running one or more functional modules in information processing apparatus such as general purpose processors or application specific chips. These modules, combinations of these modules, and/or their combination with general hardware (e.g., as described above with respect to FIGS. 1A and 3) are all included within the scope of protection of the invention.

The operations described above with reference to FIGS. 6A-6D may be implemented by components depicted in FIGS. 1A-1B. For example, detection operations 604 and 606, and displaying operations 614 and 624 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An electronic device, comprising:
a touch-sensitive display;
one or more sensors;
one or more processors;
memory; and
one or more programs, wherein the one or more programs are stored in the memory and configured to be executed by the one or more processors, the one or more programs including instructions for:
displaying an application interface on the display;
detecting an input that corresponds to a command to display a virtual keyboard in the application interface;
detecting one or more sensor inputs from the one or more sensors;
in response to detecting the input that corresponds to the command to display the virtual keyboard:
in accordance with a determination that the sensor inputs satisfy one or more first criteria, displaying the virtual keyboard as a split keyboard on the display; and
in accordance with a determination that the sensor inputs satisfy one or more second criteria, distinct from the first criteria, displaying the virtual keyboard as an unsplit keyboard on the display.

2. The device of claim 1, wherein the sensors include one or more of: one or more accelerometers, one or more gyroscopic sensors, one or more image sensors, one or more proximity sensors, and one or more touch-sensitive surfaces distinct from the touch-sensitive display.

3. The device of claim 2, wherein the one or more touch-sensitive surfaces are located on a backside of the device, opposite the touch-sensitive display.

4. The device of claim 1, wherein the first criteria include that the sensor inputs indicate the touch-sensitive display is oriented within a first predefined range of angles with respect to the ground.

5. The device of claim 1, wherein the first criteria include that the sensor inputs indicate the device is shaking by less than a predefined threshold amount.

6. The device of claim 1, wherein the first criteria include that the sensor inputs detect a face in front of the touch-sensitive display.

7. The device of claim 1, wherein the first criteria include that the sensor inputs indicate the device is being held by a user.

8. The device of claim 1, wherein the second criteria include that the sensor inputs indicate the touch-sensitive display is oriented within a second predefined range of angles with respect to the ground.

9. The device of claim 1, wherein the second criteria include that the sensor inputs indicate the device is shaking by more than a predefined threshold amount.

10. The device of claim 1, wherein the second criteria include that the sensor inputs do not detect a face in front of the touch-sensitive display.

11. The device of claim 1, wherein the second criteria include that the sensor inputs indicate the device is lying on a surface.

12. The device of claim 1, including instructions for:
in response to detecting the input that corresponds to the command to display the virtual keyboard:
in accordance with a determination that the sensor inputs do not satisfy the one or more first criteria and do not satisfy the one or more second criteria:
displaying the virtual keyboard as a split keyboard on the display if the split keyboard was the last keyboard displayed prior to detecting the input that corresponds to the command to display the virtual keyboard; and
displaying the virtual keyboard as an unsplit keyboard on the display if the unsplit keyboard was the last keyboard displayed prior to detecting the input that corresponds to the command to display the virtual keyboard.

13. The device of claim 1, including instructions for:
in response to detecting the input that corresponds to the command to display the virtual keyboard:
in accordance with a determination that the sensor inputs do not satisfy the one or more first criteria and do not satisfy the one or more second criteria:
displaying the virtual keyboard as a split keyboard on the display if the split keyboard was the last keyboard displayed in the application interface prior to detecting the input that corresponds to the command to display the virtual keyboard; and
displaying the virtual keyboard as an unsplit keyboard on the display if the unsplit keyboard was the last keyboard displayed in the application interface prior to detecting the input that corresponds to the command to display the virtual keyboard.

14. The device of claim 1, including instructions for:
in response to detecting the input that corresponds to the command to display the virtual keyboard:
in accordance with a determination that the sensor inputs do not satisfy the one or more first criteria and do not satisfy the one or more second criteria:
displaying the virtual keyboard as a split keyboard on the display if the split keyboard is a default keyboard; and
displaying the virtual keyboard as an unsplit keyboard on the display if the unsplit keyboard is the default keyboard.

15. The device of claim 1, wherein the split keyboard includes an unsplit keyboard selection key, the unsplit keyboard selection key configured to replace display of the split keyboard with display of the unsplit keyboard when activated.

16. The device of claim 15, including instructions for replacing the unsplit keyboard selection key with a keyboard dismissal key when a predefined condition is satisfied, the keyboard dismissal key configured to cease display of the split keyboard when activated.

17. The device of claim 16, wherein the predefined condition includes displaying the unsplit keyboard selection key for a predefined time.

18. The device of claim 1, wherein the unsplit keyboard includes a split keyboard selection key, the split keyboard selection key configured to replace display of the unsplit keyboard with display of the split keyboard when activated.

19. The device of claim 18, including instructions for replacing the split keyboard selection key with a keyboard dismissal key when a predefined condition is satisfied, the keyboard dismissal key configured to cease display of the unsplit keyboard when activated.

20. The device of claim 19, wherein the predefined condition includes displaying the split keyboard selection key for a predefined time.

21. A method, comprising:
at an electronic device with a touch-sensitive display and one or more sensors:
displaying an application interface on the display;
detecting an input that corresponds to a command to display a virtual keyboard in the application interface;
detecting one or more sensor inputs from the one or more sensors;
in response to detecting the input that corresponds to the command to display the virtual keyboard:
in accordance with a determination that the sensor inputs satisfy one or more first criteria, displaying the virtual keyboard as a split keyboard on the display; and
in accordance with a determination that the sensor inputs satisfy one or more second criteria, distinct from the first criteria, displaying the virtual keyboard as an unsplit keyboard on the display.

22. A computer readable storage medium storing one or more programs, the one or more programs comprising instructions, which when executed by an electronic device with a touch-sensitive display and one or more sensors, cause the device to:
display an application interface on the display;
detect an input that corresponds to a command to display a virtual keyboard in the application interface;
detect one or more sensor inputs from the one or more sensors;
in response to detecting the input that corresponds to the command to display the virtual keyboard:
in accordance with a determination that the sensor inputs satisfy one or more first criteria, display the virtual keyboard as a split keyboard on the display; and
in accordance with a determination that the sensor inputs satisfy one or more second criteria, distinct from the first criteria, display the virtual keyboard as an unsplit keyboard on the display.

23. A graphical user interface on an electronic device with a touch-sensitive display and one or more sensors, a memory, and one or more processors to execute one or more programs stored in the memory, the graphical user interface comprising:
an application interface;
wherein:
in response to detection of an input that corresponds to a command to display a virtual keyboard in the application interface:
in accordance with a determination that one or more sensor inputs detected from the one or more sensors satisfy one or more first criteria, displaying the virtual keyboard as a split keyboard on the display; and
in accordance with a determination that the sensor inputs satisfy one or more second criteria, distinct from the first criteria, displaying the virtual keyboard as an unsplit keyboard on the display.
